(19) United States
(12) Patent Application Publication
(10) Pub. No.: US 2024/0263634 A1
(43) Pub. Date: Aug. 8, 2024

(54) TANK PUMP HAVING A TANGENTIAL FEED INLET AND VARIABLE GEOMETRY INFEED SHELF

(71) Applicant: FLSmidth A/S, Valby (DK)

(72) Inventor: Luis Fernando Echeverri, Tucson, AZ (US)

(21) Appl. No.: 18/564,053

(22) PCT Filed: May 24, 2022
(86) PCT No.: PCT/IB2022/054843

§ 371 Date: Nov. 24, 2023

Related U.S. Application Data
(60) Provisional application No. 63/192,150, filed on May 24, 2021.

(51) Int. Cl. F04D 13/08

(52) U.S. Cl. CPC F04D 13/08

(57) ABSTRACT

A variable geometry infeed shelf (23) is configured to be installed within a tank pump (1) and provides supplemental internal rigid stationary fluid boundary surfaces within a cylindrical tank assembly (7) of the tank pump (1). The variable geometry infeed shelf (23) promotes uniform distribution of feeding flow around the entire volume of the tank, favouring retention time and reducing bypassing and local peak vertical velocities of a tank infeed flow path (45) in a vertical direction (Z₁) within the tank assembly (7). By virtue of its design, the variable geometry infeed shelf (23) reduces stagnation zones, air entrainment and turbulence within the tank assembly (7), thereby improving pumping efficiency of a centrifugal pump (20) operating within the tank assembly (7).

### FIELD OF THE INVENTION

Embodiments of the present invention pertain to improvements to tanks having tangential feed inlets, tank pumps having vertical pumps (i.e., ‘tank vertical pumps’), and other apparatus comprising submersible pumps. In particular, embodiments of the present invention relate to a unique variable geometry infeed shelf for use within a tank pump or other industrial cylindrical tank having a tangential feed inlet.

### BACKGROUND TO THE INVENTION

Reference to background art herein is not to be construed as an admission that such art constitutes common general knowledge in the arts.

In many industrial processes, pumps are used to convey liquids, slurries containing liquids and solids, and/or liquids containing gaseous fluids (e.g., froth) between components of processing circuit. In some processing circuits, inline pumps may be positioned between transport pipes at its respective inlet and outlet ends, in order to move material between areas of a processing circuit.

Some processing circuits may comprise holding tanks configured with a pump disposed within a tank or sump (e.g., submersible/immersible pumps). Such devices might be referred to as tank pumps, vertical pumps, vertical sump pumps, vertical submerged pumps, and/or vertical tank pumps, without limitation. These devices may be used as holding tanks or buffering tanks and can be especially useful for liquid, slurry, and/or froth pumping purposes. For example, such devices may be used in mineral processing facilities to transport froth overflow recovered from froth flotation processes to one or more downstream processing steps.

U.S. Pat. Nos. 6,854,957, 6,315,530, 3,936,221, and International Patent Application Publication WO04022979A 1, depict some relevant examples of pumps that have been proposed to date. Other examples of pumps that have been proposed to date include the Metso® brand VT vertical tank pump, Sala VT-series vertical tank pump, Sala SPV-series vertical tank pump, the Weir Group's Warman® Hazleton®, and Floway® brand vertical slurry pumps (e.g., the Warman® WBV® ultra heavy-duty vertical cantilevered slurry pump), and FLSmidth's Krebs® vMAX™ vertical cantilever pump. US 2011/079563 A1 depicts additional prior art.

Discrete tangential inlet designs alone, result in non-uniform distribution of incoming flows. It has been discovered that during pumping operations, non-uniform infeed flow directions and velocities (especially for froths) can negatively affect pumping efficiency due to vortices, phase segregations, and turbulent flow regimes adjacent a submersible pump's inlet. Thus, there is a long felt need to provide a more robust and efficient tank pump design which is configured to provide a more uniform and stable introduction of infeed fluids to be pumped. Traditional volute-style tank entrances with involuted walls (similar to centrifugal pumps and cyclones) would ideally produce uniform feeding around the entire circumference tank pump, but would negatively result in a tank design that is relatively complex to manufacture, that would difficult to structurally support the pump mass above the tank and corresponding dynamic loads, and/or which would increase footprint size and costs to manufacture.

Embodiments of the present invention aim to improve upon existing submersed tank pump devices by incorporating structures which provide more homogeneous and uniform flow introductions of fluids to be conveyed by pumping (including fluids which comprise solids or gasses).

More particularly, embodiments of the present invention aim to obtain uniform feeding around the entire tank assembly which can be preferable and beneficial to minimize air entrainment, maximize residence time, avoid dead zones and corresponding settling or sanding potential issues, and maximize the probability of air disengagement favoring pumping performance and downstream operations.

### OBJECTS OF THE INVENTION

It is an aim that embodiments of the invention provide an improved tank pump apparatus which overcomes or ameliorates one or more of the disadvantages or problems described above, or which at least provides a useful alternative to conventional tank pump apparatus.

Particular aims of embodiments of the invention include providing a tank pump apparatus which exhibits enhanced hydraulic design, minimizes solids settling and/or air entrainment, improved wear characteristics, better efficiency, and/or improved overall tank pump performance over conventional offerings.

Embodiments of the present invention may aim to obtain uniform feeding around the entire tank assembly, which can be beneficial to minimize air entrainment, maximize residence time, avoid dead zones and corresponding settling or sanding potential issues, and/or maximize the probability of air disengagement favoring pumping performance and downstream operations.

Another goal of some of the present embodiments is to provide an improved sump or tank pump design which incorporates a traditional tangential inlet to a cylindrical vessel, and which is capable of producing a vortex and discharging the incoming feeding flow uniformly around the entire tank, whilst maintaining an overall geometry that is simple, structurally strong, and easy and economical to manufacture. It should be understood that not all of the aforementioned benefits may be achieved by any one particular embodiment. However, it is anticipated that each embodiment may exhibit at least one of the aforementioned benefits.

Other preferred objects of the present invention will become apparent from the following description.

### SUMMARY OF INVENTION

According to embodiments of the invention, a tank pump (1) is disclosed.

A variable geometry infeed shelf (23) may be configured for installation within a tank pump (1). The variable geometry infeed shelf (23) may be configured to provide supplemental internal rigid stationary fluid boundary surfaces within a cylindrical tank assembly (7) of the tank pump (1) which are intended to and/or configured to produce uniform distribution of an incoming flow. The variable geometry infeed shelf (23) may be annular. The variable geometry infeed shelf (23) may be configured to protrude radially-inwardly from a cylindrical inner surface of a tank wall (8) of said tank assembly (7), for example, below a tangential infeed conduit (9) to the tank assembly (7).

The variable geometry infeed shelf (23) may be defined between a continuous annular inner edge (40) and a continuous annular outer edge (41). The variable geometry infeed shelf (23) may be configured to abut said inner surface of the tank wall (8), for example, along said continuous annular outer edge (41) below an upper rim (35) of the tank assembly (7) and below an inlet orifice (22) of the tangential infeed conduit (9).

The variable geometry infeed shelf (23) may comprise a maximum radial width (D). The maximum radial width (D) may be located at a third point (31) on the continuous annular inner edge (40), for example, adjacent the inlet orifice (22) of the tangential infeed conduit (9). The third point (31) and/or maximum radial width (D) may be positioned to be downstream of an infeed flow path (45) aligned with the tangential infeed conduit (9).

The variable geometry infeed shelf (23) may comprise a minimum radial width (J). The minimum radial width (J) may be located at a first point (27) on the continuous annular inner edge (40). A first section (26) of the variable geometry infeed shelf (23) may be configured to extend circumferentially along the cylindrical inner surface of the tank wall (8) in a circumferential direction (Z2) between a first polar angle (81) measured at the third point (31) to a second polar angle (82) measured at the first point (27).

A transitioning blend or radius section (37) of the variable geometry infeed shelf (23) may bridge end portions of the first section (26) and/or span the distance between the first point (27) and the third point (31). The transitioning blend or radius section (37) may be configured to extend circumferentially in the circumferential direction (Z2), for example, along the cylindrical inner surface of the tank wall (8) between the first point (27) and the third point (31).

The variable geometry infeed shelf (23) may comprise a transitioning radial width (K). The transitioning radial width (K) of the transitioning blend or radius section (37) may be located at a second point (29) on the continuous annular inner edge (40) between the first point (27) and the third point (31). An instantaneous radial width (I) of the first section (26) of the variable geometry infeed shelf (23) may gradually decrease from the first polar angle (81) to the second polar angle (82).

The transitioning radial width (K) is preferably less than the maximum radial width (D), but greater than the minimum radial width (J).

In some embodiments, the instantaneous radial width (I) of the variable geometry infeed shelf (23) gradually decreases at the same rate of change from the first polar angle (81) to the second polar angle (82) in the circumferential direction (Z2).

In some embodiments, the transitioning blend or radius section (37) of the variable geometry infeed shelf (23) has a second section (28). A portion of the continuous annular inner edge (40) defining the second section (28) may have a first radius (r1) between the first point (27) and the second point (29).

In some embodiments, the transitioning blend or radius section (37) of the variable geometry infeed shelf (23) may have a third section (30). A portion of the continuous annular inner edge (40) defining the third section (30) may have a second radius (r2) between the second point (29) and the third point (31).

In some embodiments, the variable geometry infeed shelf (23) protrudes radially-inwardly from the cylindrical inner surface of a tank wall (8) of said tank assembly (7) at a vertical distance (H) below an edge of the infeed orifice (22) of the tangential infeed conduit (9) to the tank assembly (7).

In some embodiments, the vertical distance (H) may be zero mm. In some embodiments, the vertical distance (H) may be greater than zero mm.

In some embodiments, an angle (a) formed between the first polar angle (81) and the second polar angle (82) may be between 270 and 315 degrees.

In some embodiments, the variable geometry infeed shelf (23) may extend 360 degrees around the cylindrical inner surface of the tank wall (8) of said tank assembly (7), for example, continuously.

In some embodiments, the variable geometry infeed shelf (23) may be substantially planar in shape. It is envisaged that while not shown, alternative embodiments of the variable geometry infeed shelf (23) may comprise conical or sloped surfaces, undulating surfaces, one or more apertures extending through the variable geometry infeed shelf (23), one or more baffles extending from the variable geometry infeed shelf (23), or a combination thereof. It is further envisaged that the variable geometry infeed shelf (23) may comprise a rigid material (e.g., metal, hard urethane or polymer-coated metallic substrate), or, it may comprise a flexible material (e.g., soft urethane, rubber, or other flexible polymer).

In some embodiments, the variable geometry infeed shelf (23) may be provided below an upper rim (35) of the tank assembly (7), for example, in an upper half of the tank assembly (7).

In some embodiments, the variable geometry infeed shelf (23) may be configured to reduce velocity of a tank infeed flow path (45) in a vertical direction (Z1) within the tank assembly (7).

A tank pump (1) may comprise a cylindrical tank assembly (7), a drive assembly (2), a centrifugal pump (20), and a variable geometry infeed shelf (23) as described above. The drive assembly (2) of the tank pump (1) may comprise a motor (3) and optional transmission (4). The drive assembly (2) may be provided atop the tank assembly (7). The centrifugal pump (20) of the tank pump (1) may be positioned in a lower half of the tank assembly (7) and may comprise a pump inlet (33) and a volute section (21). The centrifugal pump (20) may be driven by a drive shaft (19) that is operably connected to the drive assembly (2). The tank pump (1) may include an outlet conduit (6) which may extend vertically upwardly from the volute section (21) of the centrifugal pump (20).

A method of manufacturing a tank pump (1) is further disclosed. The tank pump (1) may have a cylindrical tank assembly (7), a centrifugal pump (20) therein, and a drive assembly (2). The drive assembly (2) may comprise a motor (3) and an optional transmission (4). The drive assembly (2) may be provided atop the tank assembly (7). The method of manufacturing the tank pump (1) may include the step of installing the variable geometry infeed shelf (23) described above into a cylindrical tank assembly (7) of the tank pump (1), for example, at a location which is below an upper rim (35) of the tank assembly (7) in an upper half of the tank assembly (7). The location of the variable geometry infeed shelf (23) may also be below a tangential infeed conduit (9) to the tank assembly (7). The variable geometry infeed shelf (23) may be installed such that it provides supplemental internal rigid stationary fluid boundary surfaces within the tank assembly (7) of the tank pump (1) and/or such that it protrudes radially-inwardly from a cylindrical inner surface of a tank wall (8) of said tank assembly (7) below a tangential infeed conduit (9) to the tank assembly (7).

Further features and advantages of the present invention will become apparent from the following detailed description.

### BRIEF DESCRIPTION OF THE DRAWINGS

Byway of example only, preferred embodiments of the invention will be described more fully hereinafter with reference to the accompanying figures. It will be appreciated from the drawings that some of FIGS. 1-10 intentionally omit features or hide components for clarity and better visualization and understanding.

FIG. 1 is an isometric representative view illustrating a tank pump (1) according to non-limiting embodiments of the invention.

FIG. 2 is an alternative depiction of the tank pump (1) shown in FIG. 1, without showing the drive assembly (2) and cover plate (13) of FIG. 1 to more clearly display a drive shaft (19), central tube (14) and outlet conduit (6) within the tank pump (1).

FIG. 3 shows a top plan view of FIG. 2, to more clearly display a centrifugal pump (20) within a tank assembly (7) of the tank pump (1).

FIG. 4 shows a partial side cutaway view of FIGS. 2 and 3 to more clearly display a variable geometry infeed shelf (23) pump (20), and inlet cage (32).

FIG. 5 is an alternative depiction of FIG. 4, further hiding the pump (1) and entire central assembly thereof, in order to more clearly display features of the variable geometry infeed shelf (23).

FIG. 6 shows a non-cutaway top plan view of what is depicted in FIGS. 4 and 5.

FIG. 7 schematically illustrates a preferred geometry of a variable geometry infeed shelf (23) with respect to a tangential infeed conduit (9), according to some embodiments.

FIG. 8 schematically illustrates an example of expected flow velocities within a tank pump (1) adjacent the variable geometry infeed shelf (23) of FIG. 7. As can be appreciated from the velocity contours in this figure, the variable geometry infeed shelf (23) according to embodiments of the invention is configured to provide a reasonably uniform velocity around its inner boundary, thus, leading to reasonably uniform distributions of flow within the tank assembly (7).

FIGS. 9 & 11 schematically illustrate examples of expected flow streamlines entering a tank pump (1) having a variable geometry infeed shelf (23) according to embodiments of the invention. The flow streamlines suggest that a tank provided with the novel variable geometry infeed shelf (23) having a central involuted passage may promote a reasonably uniform velocity field around a cylindrical tank provided with a tangential infeed conduit (inlet) in contrast to designs without the shelf (e.g., those depicted in FIGS. 10 & 12).

FIGS. 10 & 12 schematically illustrate examples of expected flow streamlines entering a tank pump (1) which omits the variable geometry infeed shelf (23) according to FIGS. 9 & 11, respectively, but represent the same timeframe. As can be appreciated from these figures, a tangential feed inlet to a cylindrical tank, alone, can exhibit a rapid local descend of the incoming flow, sinking and rapidly reaching the bottom (11) region of the tank, thus negatively affecting residence time, increasing the risk of air entrainment, and reducing the probability of air disengagement

FIG. 13 is an upward-facing view of an expected flow regime below a variable geometry infeed shelf (23) according to embodiments of the invention. In particular, this figure suggests that a variable geometry infeed shelf having central involuted passage may encourage velocity fields which are more uniform and lower peak velocities that would result in a more uniform distribution of infeed flow around a cylindrical tank provided with a tangential infeed conduit (inlet).

FIG. 14 represents an alternative view of FIG. 13.

FIG. 15 suggests that a false bottom (47) may be employed to the tank assembly 7, for example, a dished, frustroconical, or parabaloid-shaped wall may be provided above the bottom (11) of tank assembly (7).

FIG. 16 suggests that an overflow launder or weir box (48) may be provided to an upper portion of the tank assembly (7). An opening, spill lip, or weir (50) may be provided to an upper portion of the tank assembly (7), e.g., through the tank wall (8), such that the overflow launder or weir box (48) can fluidly communicate with the contents of tank assembly (7). A discharge pipe (49) may move the contents of the overflow launder or weir box (48) to a downstream process step or a holding tank, without limitation.

### DETAILED DESCRIPTION OF THE DRAWINGS

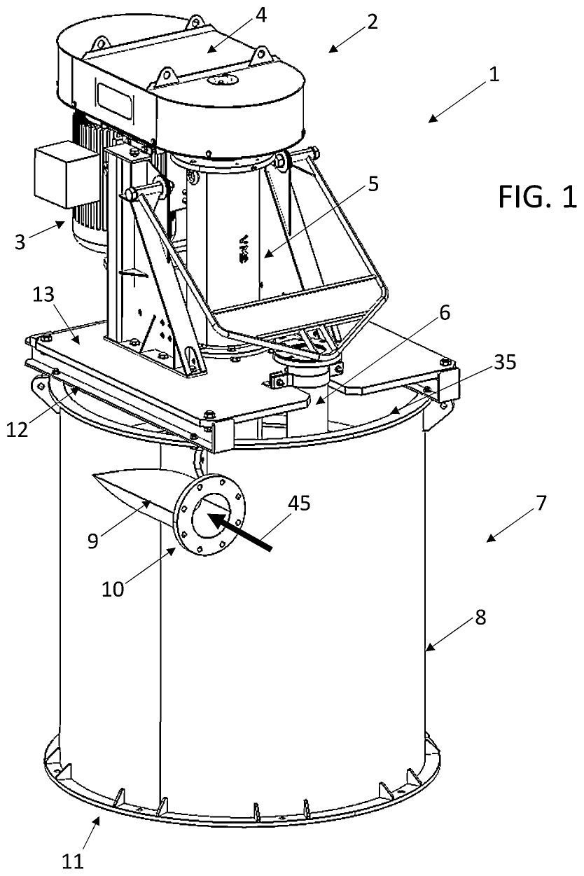

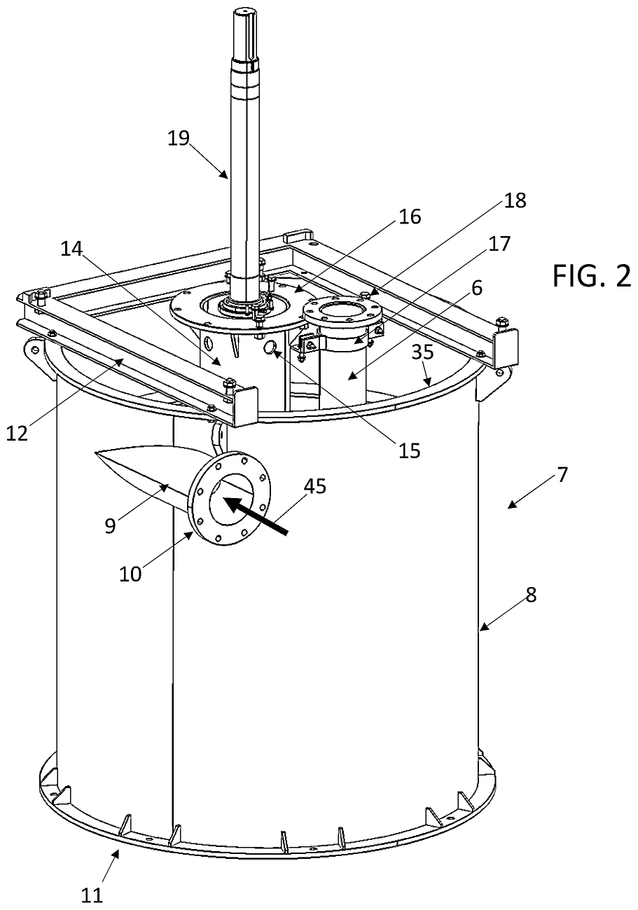

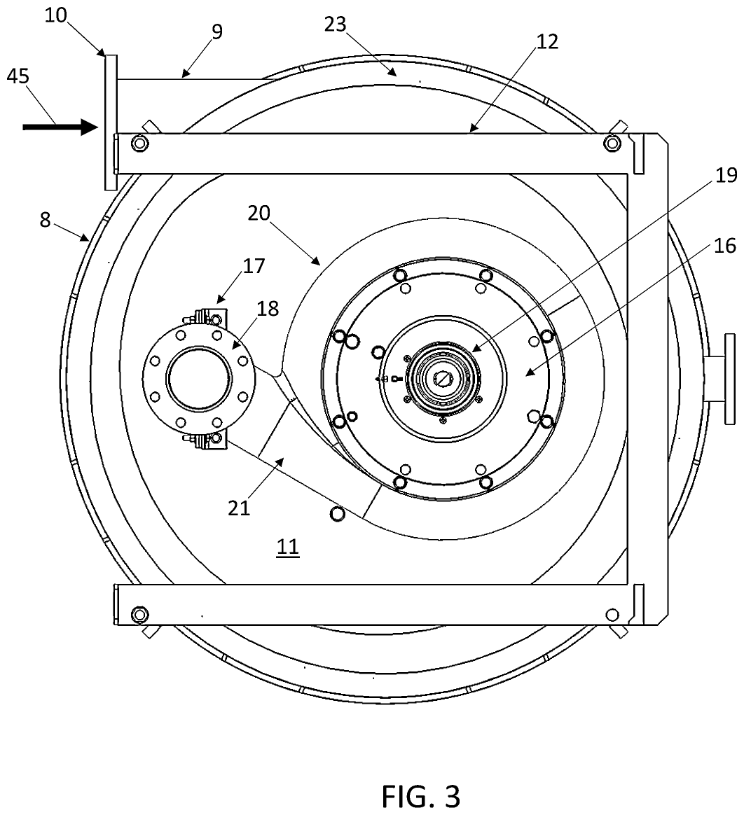

As shown in FIG. 1, a tank pump 1 may comprise a tank assembly 7 having a drive assembly 2 thereon. The drive assembly 2 is preferably located atop the tank assembly 7, and may be supported on an upper rim 35 of the tank assembly 7 via a lower mount 12. The lower mount 12 may comprise one or more supporting structures such as trusses or beams (e.g., one or more I-beams as shown), without limitation.

The drive assembly 2 may comprise a motor 3 operably connected to a drive shaft 19 via an optional transmission 4. An upper mount 5 may be used to connect portions of the drive assembly 2 to the tank assembly; for example, via the lower mount 12 as shown. A structurally rigid cover plate 13 may be provided to the upper mount 5 and/or to the lower mount 12. For example, the cover plate 13 may be provided between the upper mount 5 and the lower mount 12 as depicted. The cover plate 13 transfers all pump loads to the tank and may be used as a platform for securing components, and may dually-serve as a splash guard or protective cover for the tank assembly 7 to discourage spraying or for safety measures to prevent foreign objects from falling into the tank assembly 7.

The drive shaft 19 may be coupled to an impeller of a immersible/submersible pump, such as a centrifugal pump 20 as depicted. The centrifugal pump 20 may be arranged vertically as shown, with its volute portion 21 extending radially outwardly and/or circumferentially, in a circumferential direction z2, without limitation. The pump 33 may be disposed within a lower central portion of the tank assembly 7 as depicted. A pump inlet 33 of the centrifugal pump may comprise a central opening facing a bottom 11 of the tank assembly 7, to ingest contents within lower portions of the tank assembly 7. To protect against ingestion of foreign debris and/or tramp material, an inlet cage or strainer 32 may be provided to cover or surround the pump inlet 33. There is preferably a gap or vertical spacing between the pump inlet 33 and the bottom of the tank along vertical direction Z1.

An outlet conduit 6 may be operably connected to the volute portion 21 of the centrifugal pump 20. The outlet conduit 6 may extend vertically upwardly within the tank assembly as shown, for example, in a vertical direction Z1. The outlet conduit 6 may be supported, for example, by a clamp 17, which may be secured to the cover plate 13 as shown. It should be understood that while not shown, clamp 17 may secure to other components such as the lower mount 12, upper mount 5, or upper rim 35, without limitation. A connecting discharge flange 18 may be provided at an upper end of outlet conduit 6 for securing the outlet conduit 6 to piping leading to downstream equipment within a processing circuit.

The tank assembly 7 may comprise a cylindrical tank wall 8 defining a vertically-oriented tube, and a tank assembly diameter F. The tank wall 8 may be bounded at its upper end by the upper rim 35, and enclosed at its bottom 11 by a planar panel. The tank assembly 7 may be configured to hold contents including mixtures of liquids, solids, and/or gas—and may be configured to receive such contents via a tangential infeed conduit 9 located adjacent an upper portion of the tank assembly 7 below the upper rim 35. A connecting suction flange 10 may be provided to the tangential infeed conduit 9 for securing the tangential infeed conduit 9 to piping leading to upstream equipment within a processing circuit. There is preferably a gap or lateral/radial spacing between the pump inlet 33 and an inner surface of tank wall 8.

A central tube 14 may extend downwardly within the tank assembly and protect drive shaft 19. The central tube 14 may, thus, extend between the drive assembly 2 and centrifugal pump 20. The central tube 14 may comprise one or more upper ports 15 for venting to atmosphere. The central tube 14 may comprise one or more lower ports 34 for equalizing impeller backpressure against tank fluid level and allow any large solids to escape. The central tube 14 may comprise a connecting flange 16 at its upper end for securing to the cover plate 13 and/or upper mount 5 of the drive assembly 2. Depending on configuration, while not shown, it is also envisaged that the connecting flange 16 could also be configured to connect to the lower mount 12.

Tank assembly 7 may further comprise an inlet orifice 22 defining an open intersection between the tangential infeed conduit 9 and the tank wall 8. As depicted, the inlet orifice 22 may be generally horizontally drop-shaped, with its distal (e.g., “pointy”) side or end 46 being located adjacent a third point 31 of a variable geometry infeed shelf 23 as will be described hereinafter. In this regard, a tank infeed flow path 45 extending through the tangential infeed conduit 9 will preferably encounter a maximum radial width D of the variable geometry infeed shelf 23 at the third point 31 immediately or in close proximity downstream of the inlet orifice 22 (e.g., adjacent its distal side or end 46, without limitation). A vertical distance L between the distal side or end 46 may be greater than a vertical distance H described below.

An inventive variable geometry infeed shelf 23 may be provided to the tank assembly 7 in the manner illustrated and described below.

The variable geometry infeed shelf 23 may comprise an annular surface defined between a continuous annular inner edge 40 and a continuous annular inner edge 41. The variable geometry infeed shelf 23 may have an upper surface 24 and a lower surface 25, defining a radially-inner edge.

The variable geometry infeed shelf 23 may comprise multiple sections. For example, a first section 26 of the variable geometry infeed shelf 23 may extend from a third point 31 to a first point 27. A transitioning blend or radius section 37 may extend between the first point 27 and the third point 31. The transitioning blend or radius section 37 may be a fillet section, without limitation. In some instances, the transitioning blend or radius section 37 may comprise a second section 28 of the variable geometry infeed shelf 23 extending between the first point 27 and a second point 29, without limitation. In some instances, the transitioning blend or radius section 37 may comprise a third section 30 of the variable geometry infeed shelf 23 extending between the second point 29 and the third point 31, without limitation. The second 28 and third 30 sections may extend at different lengths around a circumference of the tank wall 8, and may comprise different radii. For example, the second section 28 may comprise a second radius r2. The third section 30 may comprise a second radius r2. In the particular non-limiting representative embodiment depicted, r2 is greater than r1.

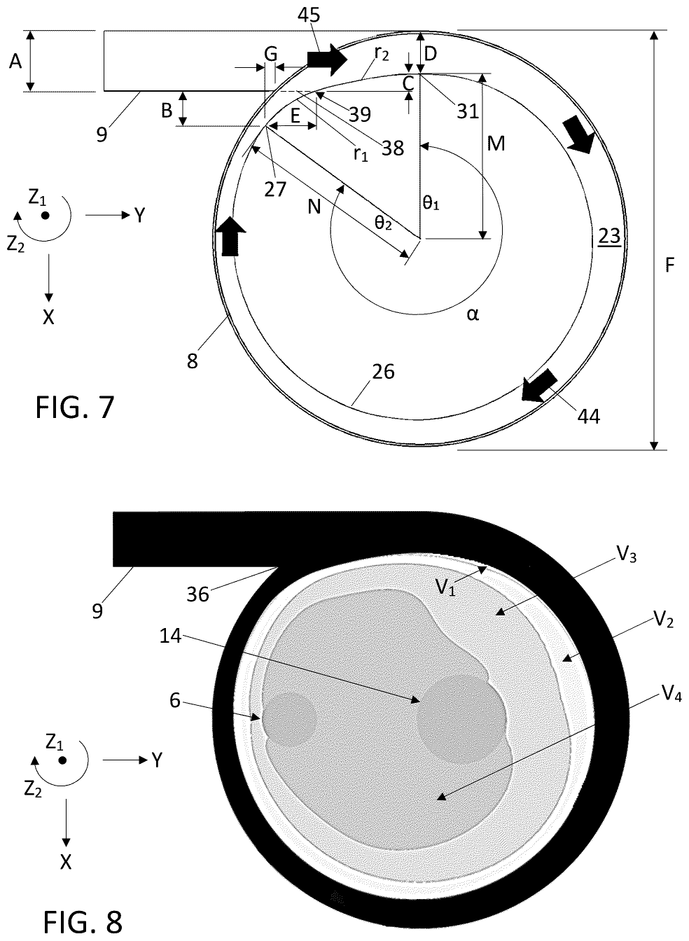

The first section 26 of the variable geometry infeed shelf 23 may, as shown, extend for an angle a between the first point 27 and the third point 31. Said differently, angle a may comprise an angle between a first polar angle 81 at least partially being defined by a polar coordinate including the third point 31, and a second polar angle 82 at least partially being defined by a polar coordinate including the first point 27 as most clearly depicted in FIG. 7.

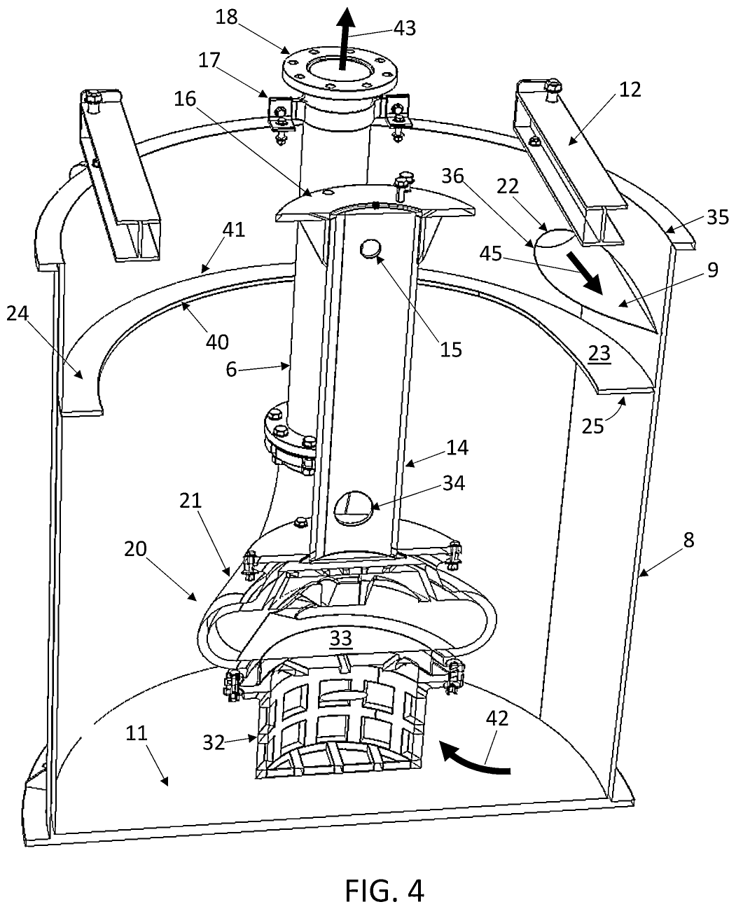

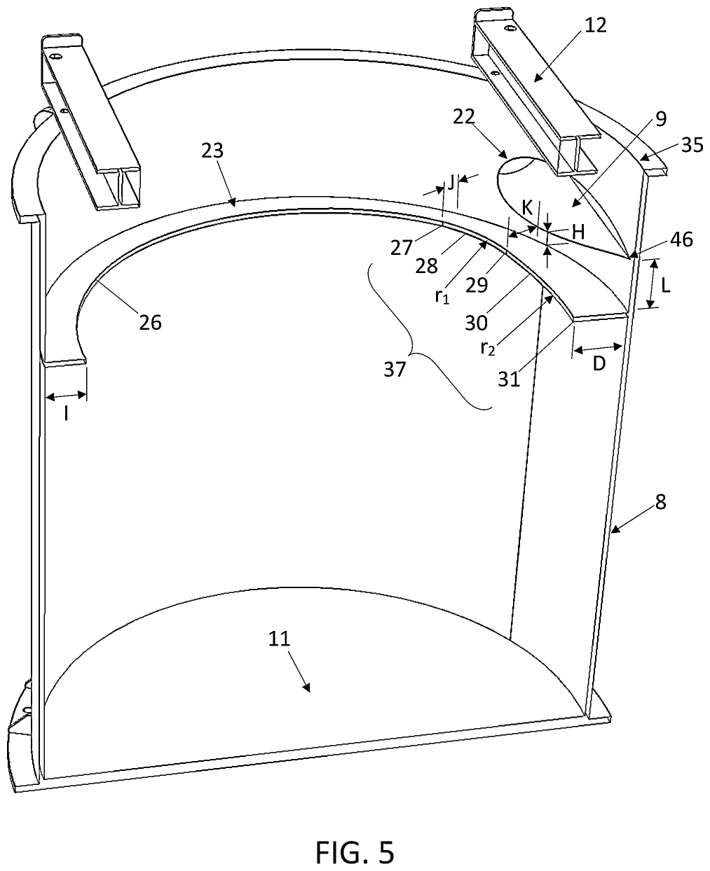

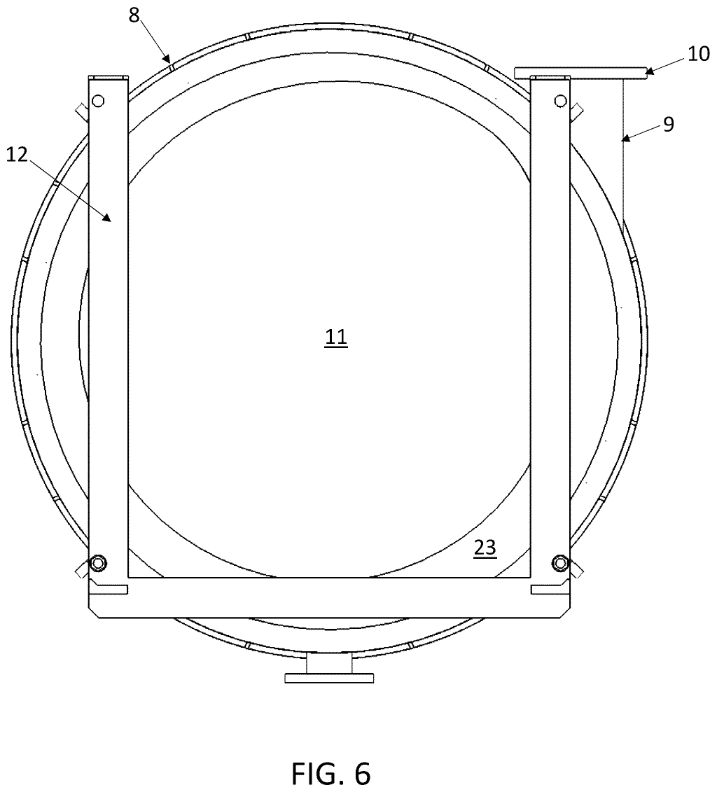

An acute intersection 36 may be present between tank wall 8 and a surface of the tangential infeed conduit 9, when the tank pump 1 is viewed from above or below along vertical axis Z1 as illustrated in FIG. 8. FIGS. 4 & 14 show alternative perspective views of the acute intersection 36 of FIG. 8. A vertical tangent projection plane 38 may extend through the acute intersection 36 and run parallel to a wall surface of the tangential infeed conduit 9. An interception point 39 may be present where this vertical tangent projection plane 38 meets the continuous annular inner edge 40 of the variable geometry infeed shelf 23.

Turning now to FIG. 7, the tangential infeed conduit 9 may comprise an average or maximum width A. There may be an X-offset B between the acute intersection 36 and the first point 27 in reference to an X-direction (or X-axis), X. There may be an X-offset C between the acute intersection 36 and the third point 31 in reference to the X-direction X. As shown, in some preferred embodiments, a maximum radial width D of the variable geometry infeed shelf 23 may be provided at or adjacent the third point 31, for example, at the first polar angle 81, without limitation. A minimum radial width J of the variable geometry infeed shelf 23 may be provided at or adjacent the first point 27, for example, at the second polar angle 82, without limitation.

A Y-offset E may exist between the first point 27 and the interception point 39 where the vertical tangent projection plane 38 meets the continuous annular inner edge 40 of the variable geometry infeed shelf 23. A Y-offset G may exist between the acute intersection 36 and the first point 27, without limitation. Y-offsets E, G may be measured in reference to a Y-Direction (or axis), Y.

The variable geometry infeed shelf 23 may be provided within the tank assembly 7, and on the tank wall 8, a vertical distance H from a lower edge of the inlet orifice 22. This vertical distance H may be zero, such that a lower point of inlet orifice 22 is tangent with upper surface 25 of the variable geometry infeed shelf 23. However, as shown, it is preferable that the vertical distance H is positive and greater than zero, such that there is at least some vertical spacing (in the vertical direction Z1), between the tangential feed conduit 9 and variable geometry infeed shelf 23.

The variable geometry infeed shelf 23 may comprise, at any given circumferential point in the circumferential direction Z2, an instantaneous radial width I. This instantaneous radial width I may change at different rates, depending on the section 26, 28, 30 of the shelf 23 being measured. A transitioning radial width K may be the instantaneous radial width I measured at the second point 29 of the variable geometry infeed shelf 23. Transitioning radial width K may be a value which is between the minimum J and maximum D radial widths mentioned above.

The tank pump 1 is preferably configured such that a feed may be introduced to the tank pump 1 via the tangential infeed conduit 9. The tank pump 1 is further preferably configured such that the feed initially follows a tank infeed flow path 45 which is aligned with a central axis of the tangential infeed conduit 9, and which may be substantially tangential with respect to the tank wall 8 of the tank assembly 7. The introduced feed subsequently passes through the inlet orifice 22 and encounters the variable geometry infeed shelf 23 below, where it continues to follow a circular flow path 44 around inside portions of the tank wall 8. As the flow of the introduced feed traverses circumferentially around the variable geometry infeed shelf 23, the introduced feed slowly and incrementally spills over the continuous annular inner edge 40 of the variable geometry infeed shelf 23, and enters deeper into the tank assembly 7 where it combines or mixes with other contents within the tank assembly. As it approaches a lower portion of the tank assembly 7 proximate the bottom 11, it follows a pump infeed flow path 42 where it passes through inlet cage 32 and pump inlet 33 and ingested into centrifugal pump 20 and finally discharged through volute portion 21 and out of the outlet conduit 6 in a pump discharge flow path 43.

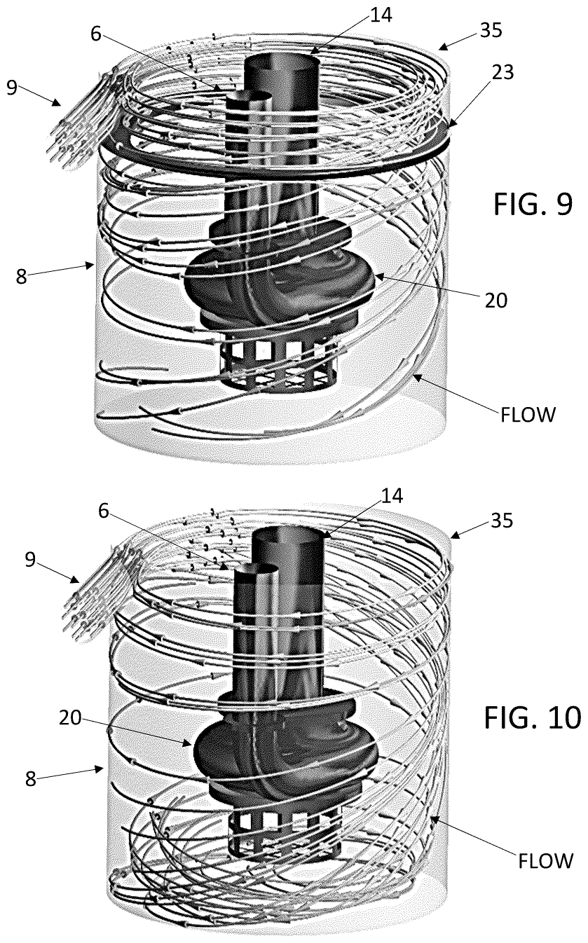

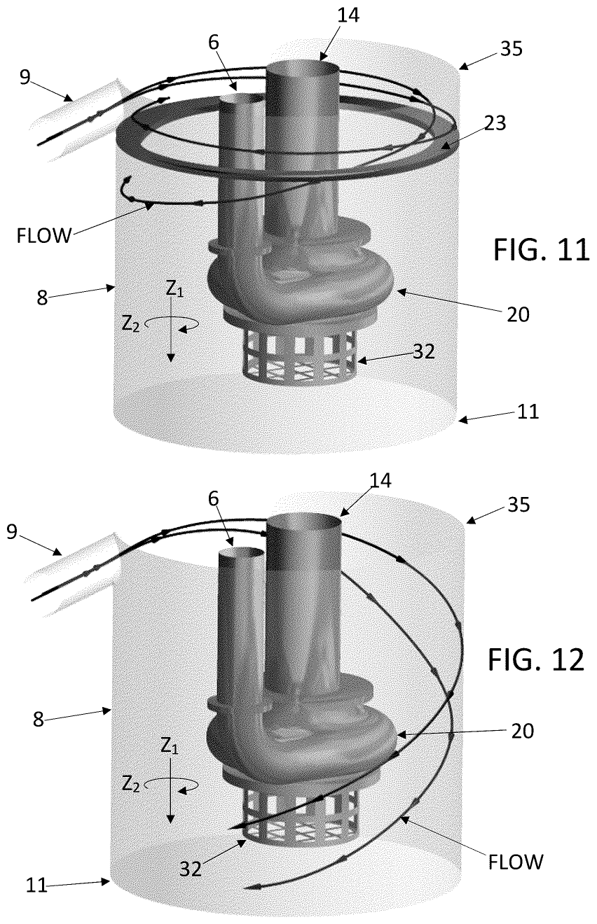

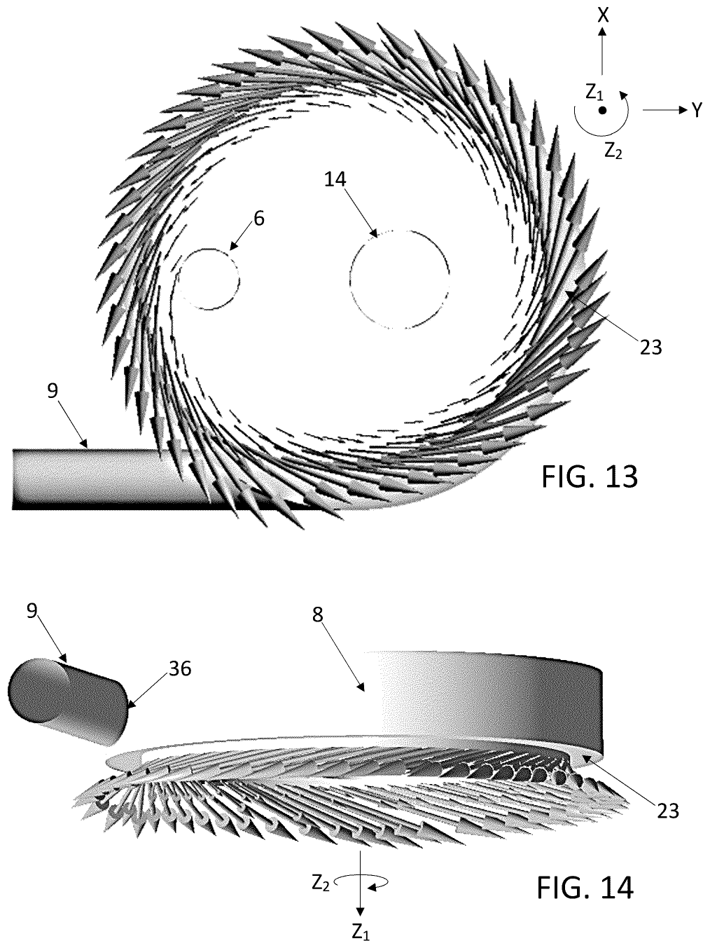

The tank pump 1 having the novel variable geometry infeed shelf 23 described herein is thus configured to, as demonstrated by FIGS. 9 and 11, produce a more uniform flow distribution within tank assembly 7 with better retention time and less flow bypassing the tank volume near bottom 11 and pump inlet 33. Comparing what is shown in FIGS. 9 and 11 to that depicted in FIGS. 10 and 12, it can be appreciated by those skilled in the art, that the variable geometry infeed shelf 23 produces a flow regime near the centrifugal pump 20 which is more conducive to efficient pumping. In this regard, pump infeed flow path 42 may be optimized for best wear and hydrodynamic performance of the centrifugal pump 20 and tank pump 1.

Turning now to FIG. 8, flow velocities in the vertical direction Z1 are depicted by four different velocity zones. A first velocity zone vi immediately downstream of the third point 31 and adjacent the widest portion of the first section 26 of the variable geometry infeed shelf 23 comprises the highest flow velocities of infeed to the tank pump 1 in the vertical direction Z1. A second velocity zone V2, represents the second highest flow velocities in the vertical direction Z1. A third velocity zone V3 represents a zone comprising the third highest flow velocities in the vertical direction Z1. Lastly, a fourth velocity zone V4 represents an area where flow velocities in the vertical direction Z1 are smallest. As can be appreciated from FIG. 8, a substantially uniform distribution of vertical flow velocities can be achieved with the cost effective tank design disclosed herein, without involving an outer volute structure provided to tank assembly 7.

Thus, an (inexpensive to manufacture) cylindrical tank wall 8 can be used in conjunction with the novel variable geometry infeed shelf 23 described herein, to synergistically provide a similar effect to that of a cylindrical tank provided with a traditional (more expensive to manufacture) involute infeed structure that is substantially radially displaced outwardly from the tank wall 8 in the X-direction X (not shown).

### Example

A new method for, or a new device for distributing an incoming feed flow uniformly around sumps and tank pumps is proposed. This new solution would rely preferably on a standard cylindrical tank geometry provided with a standard tangential inlet, combined with a custom designed annular shelf, or “flow-carrying” plate. This custom designed shelf would display a circular periphery and a novel uniquely-configured inner central passage or discharge which is configured to provide a similar effect to a more traditional involuted feed structure.

Generally-speaking, this prosed shelf design is somewhat physically ‘opposite’ in geometry to a volute-shaped periphery, which possesses a progressively shrinking outer radius and a central circular inner passage or fluid boundary surface. To some extent, from a fluid mechanics and functional point of view, the proposed shelf—with its unique non-circular inner rim, is expected to functionally perform similarly to a traditional involuted infeed structure, since the width of the shelf reduces gradually, essentially forcing a progressive flow injection around the entire volume of the tank.

Initial numerical simulations have suggested that this new tank pump design provided with the newly-proposed annular shelf displaying a central non-circular involuted passage can produce reasonably good flow distribution around the tank when compared with other alternatives, achieving results that get close to what could be expected with a volute-style entrance, with the advantage being a circular or cylindrical tank infeed geometry that is simpler, easier to design and build, structurally strong, and more economical.

A volute or spiral curve may be used to define most of the geometry of the central involuted passage or discharge. Said differently, the (radial) distance between a fixed center point of the tank and an inner edge of the shelf continuously increases for an angle (a) around the fixed center point in the same direction (44) of the flow, from a minimum radius (M) to a maximum radius (N), respectively located at angular positions (81) and (82) as shown in FIG. 7. The two resulting ends of this first volute or spiral section (26) corresponding to points (31) and (27), are joined with a secondary smooth curve, tangent to the spiral on both ends, but now that reduces in radius continuously around the fixed center point to achieve a progressive transition from the maximum radius (M) to the minimum radius (N) and obtains a closed boundary for the central involuted discharge shelf proposed here.

For the first main involuted section (26), where radius grows progressively from (M) at (81) to (N) at (82) in the same direction of the flow (e.g. clockwise from the tangential inlet (9) as shown in FIG. 7), preferred shelf (23) embodiments may comprise an Archimedean or Arithmetic spiral displaying constant radial growth rate around a fixed center point of the tank (7). It is anticipated that alternative embodiments may use any other alternative type of spiral or spiral approximation, alone or combined, to achieve a similar result.

For the secondary section (37), where the radial separation between the inner involuted edge of shelf (23) and fixed center point reduces progressively from (N) to (M) in the same direction (44) of the flow, some preferred embodiments may introduce a constant radius segment just downstream from point (27) that connects with a spline defining a smooth geometrical transition that is tangent at both ends with the first main spiral section (26) and predicted (via numerical flow simulation) to promote uniform distribution. It should be understood and well-appreciated by those skilled in the art, that alternative embodiments could use portions of spirals, circular segments, linear segments, or splines, alone, or combined in various manners to achieve a similar result.

As depicted below, two main dimensions may be defined in accordance with embodiments of the present invention:

$$R tank = Tank inner radius = F / 2.$$

$$r inlet = Tangential feeding pipe inner radius = A / 2.$$

Example relative dimensional parameters proposed for novel shelf (23) with central involuted passage can be found in the below table:

| | | |
|---|---|---|
| Minimum | M/[R tank - 2*r inlet] | 0.90-1.30, and more preferably |
| radius | | 1.05-1.15, without limitation |
| Maximum | N/R tank | 0.87-0.97, and more preferably |
| radius | | 0.90-0.94, without limitation |
| Vertical | H/r inlet | 0-1.0, and more preferably |
| distance | | 0.3-0.5, without limitation |

The tank pump 1 and/or variable geometry infeed shelf 23 described and illustrated herein are provided merely as examples to which the invention of the claims may be applied. The specification does not suggest that the invention of the claims is limited to or applies only to the particular tank pump 1 and/or variable geometry infeed shelf 23 shown and described herein.

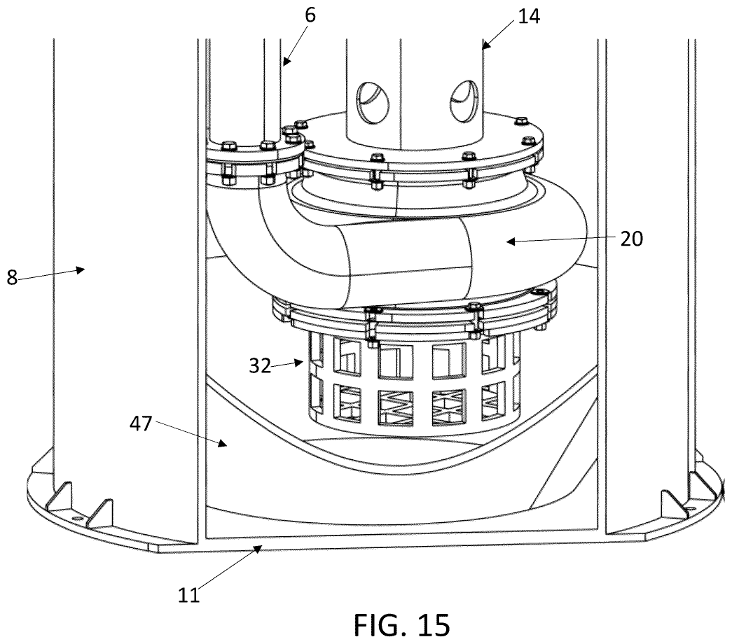

As suggested in FIG. 15, a false bottom 47 may be employed to the tank assembly 7 to further improve tank pump performance and/or optimize internal fluid boundaries for pump characteristics. Such a false bottom 47 may comprise a dished, frustroconical, or parabaloid-shaped wall member and may be provided above the bottom 11 of tank assembly 7, without limitation. The false bottom 47 may connect with the tank wall 8 at its upper outer periphery.

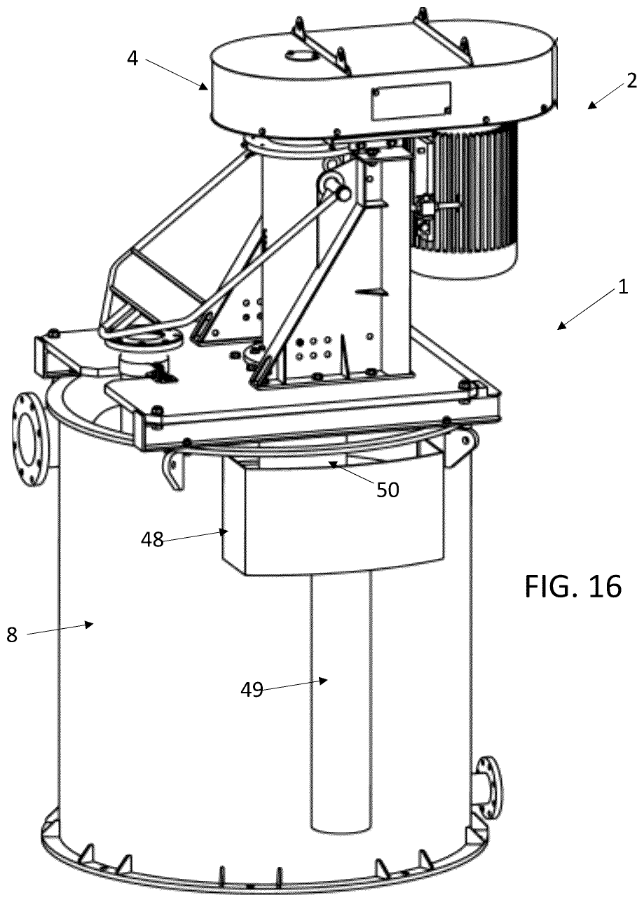

As suggested in FIG. 16, an overflow launder or weir box 48 may be provided to an upper portion of the tank assembly 7 for receiving overflow. As the level in the tank assembly 7 rises, slurry/fluid may find egress through an opening, spill lip, or weir 50 which may be optionally-provided through the tank wall 8 adjacent an upper portion of the tank assembly 7. If provided to the tank pump 1, the overflow launder or weir box 48 is configured to fluidly communicate with the contents of tank assembly 7, via the opening, spill lip, or weir 50. A discharge pipe 49 may allow transfer of the contents of the overflow launder or weir box 48 to a downstream process step or a holding tank, without limitation.

In this specification, adjectives such as first and second, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

### LIST OF REFERENCE IDENTIFIERS

1 Tank pump
2 Drive assembly
3 Motor
4 Transmission
5 Upper mount
6 Outlet conduit
7 Tank assembly
8 Tank wall
9 Tangential infeed conduit
10 Connecting suction flange (for Tangential infeed conduit 9)
11 Bottom (of Tank assembly 7)
12 Lower mount
13 Cover plate
14 Central tube
15 Upper port (of Central tube 14)
16 Connecting flange (Central tube 14)
17 Clamp
18 Connecting discharge flange (Outlet conduit 6)
19 Drive shaft
20 Centrifugal pump
21 Volute portion
22 Inlet orifice (through Tank wall 8)
23 Variable geometry infeed shelf
24 Upper surface (of Variable geometry infeed shelf 23)
25 Lower surface (of Variable geometry infeed shelf 23)
26 First section (of Variable geometry infeed shelf 23)
27 First point
28 Second section (of Variable geometry infeed shelf 23)
29 Second point
30 Third section (of Variable geometry infeed shelf 23)
31 Third point
32 Inlet cage or strainer
33 Pump inlet
34 Lower port (of Central tube 14)
35 Upper rim (of Tank assembly 7)
36 Acute intersection (between Tank wall 8 and Tangential infeed conduit 9)
37 Transitioning blend or radius section
   (between First point 27 and Third point 31)
38 Vertical tangent projection plane
   (along wall surface of Tangential infeed conduit 9)
39 Interception point (where Vertical tangent projection plane 38 meets a continuous annular inner edge 40 of the Variable geometry infeed shelf 23)
40 Continuous annular inner edge (of the Variable geometry infeed shelf 23)
41 Continuous annular outer edge (of the Variable geometry infeed shelf 23)
42 Pump infeed flow path
43 Pump discharge flow path
44 Circular flow path
45 Tank infeed flow path
46 Distal (e.g., “pointy”) side or end (of Inlet orifice 22)
47 False bottom (e.g., dished, frustroconical, parabaloid)
48 Overflow launder/weir box
49 Discharge pipe
50 Tank wall upper opening, spill lip, or weir
A Average or maximum width (of Tangential infeed conduit 9)
B X-offset (between Acute intersection 36 and First point 27)
C X-offset (between Acute intersection 36 and Third point 31)
D Maximum radial width (of Variable geometry infeed shelf 23 at Third point 31)
E Y-offset (between First point 27 and Interception point 39)
F Diameter (of tank assembly 7)
G Y-offset (between Acute intersection 36 and First point 27)
H Vertical Distance
   (between Variable geometry infeed shelf 23 and lower edge of Inlet orifice 22)
I Instantaneous radial width (of Variable geometry infeed shelf 23 at any point)
J Minimum radial width
   (of Variable geometry infeed shelf 23 at First point 27)
K Transitioning radial width
   (of Variable geometry infeed shelf 23 at Second point 29)
L Vertical Distance (at distal end of Inlet orifice 22)
M Minimum radius (of Variable geometry infeed shelf 23)
N Maximum radius (of Variable geometry infeed shelf 23)
r1 First radius (of Third section 30)
r2 Second radius (of Second section 28)
81 First polar angle (at Third point 31)
82 Second polar angle (at First point 27)
a Angle (between First point 27 and Third point 31)
X X-Direction
Y Y-Direction
Z1 Vertical direction
Z2 Circumferential direction
V1 First velocity zone
V2 Second velocity zone
V3 Third velocity zone
V4 Fourth velocity zone

What is claimed is:

1. A tank pump (1) comprising:
a cylindrical tank assembly (7);
a drive assembly (2) comprising a motor (3) and optional transmission (4) provided atop the tank assembly (7);
a centrifugal pump (20) having a pump inlet (33) in a lower half of the tank assembly (7) and a volute section (21), the centrifugal pump (20) being driven by a drive shaft (19) operably connected to the drive assembly (2); and
an outlet conduit (6) extending vertically upwardly from the volute section (21) of the centrifugal pump (20); CHARACTERISED IN THAT the tank pump (1) further comprises:
a variable geometry infeed shelf (23) configured to provide supplemental internal rigid stationary fluid boundary surfaces within the cylindrical tank assembly (7) of the tank pump (1) which produce uniform distribution of an incoming flow, the variable geometry infeed shelf (23) being annular and configured to protrude radially-inwardly from a cylindrical inner surface of a tank wall (8) of said tank assembly (7) below a tangential infeed conduit (9) to the tank assembly (7);
the variable geometry infeed shelf (23) being defined between a continuous annular inner edge (40) and a continuous annular outer edge (41), the variable geometry infeed shelf (23) being configured to abut said inner surface of the tank wall (8) along said continuous annular outer edge (41) below an upper rim (35) of the tank assembly (7) and below an inlet orifice (22) of the tangential infeed conduit (9); the variable geometry infeed shelf (23) further comprising:
a maximum radial width (D) located at a third point (31) on the continuous annular inner edge (40) adjacent the inlet orifice (22) of the tangential infeed conduit (9) and downstream of an infeed flow path (45) aligned with the tangential infeed conduit (9);
a minimum radial width (J) located at a first point (27) on the continuous annular inner edge (40);
a first section (26) configured to extend along the cylindrical inner surface of the tank wall (8) in a circumferential direction (Z2) between the third point (31) and the first point (27);
a transitioning blend or radius section (37) bridging end portions of the first section (26) and spanning the distance between the first point (27) and the third point (31) and configured to extend in the circumferential direction (Z2) along the cylindrical inner surface of the tank wall (8) between the first point (27) and the third point (31);
a transitioning radial width (K) of the transitioning blend or radius section (37) of the variable geometry infeed shelf (23) being located at a second point (29) on the continuous annular inner edge (40) between the first point (27) and the third point (31);
wherein an instantaneous radial width (I) of the first section (26) of the variable geometry infeed shelf (23) gradually decreases from the third point to the first point; and
wherein the transitioning radial width (K) is less than the maximum radial width (D) but greater than the minimum radial width (J).

2. The tank pump (1) according to claim 1, wherein the instantaneous radial width (I) of the variable geometry infeed shelf (23) gradually decreases at the same rate of change from the third point to the first point in the circumferential direction (Z2).

3. The tank pump (1) according to any one of the preceding claims, wherein the transitioning blend or radius section (37) of the variable geometry infeed shelf (23) has a second section (28); wherein a portion of the continuous annular inner edge (40) defining the second section (28) has a first radius (r1) between the first point (27) and the second point (29).

4. The tank pump (1) according to any one of the preceding claims, wherein the transitioning blend or radius section (37) of the variable geometry infeed shelf (23) has a third section (30); wherein a portion of the continuous annular inner edge (40) defining the third section (30) has a second radius (r2) between the second point (29) and the third point (31).

5. The tank pump (1) according to any one of the preceding claims, wherein the variable geometry infeed shelf (23) protrudes radially-inwardly from the cylindrical inner surface of a tank wall (8) of said tank assembly (7) at a vertical distance (H) below an edge of the infeed orifice (22) of the tangential infeed conduit (9) to the tank assembly (7).

6. The tank pump (1) according to claim 5, wherein the vertical distance (H) is zero mm.

7. The tank pump (1) according to claim 5, wherein the vertical distance (H) is greater than zero mm.

8. The tank pump (1) according to any one of the preceding claims, wherein an angle (a) between the third point and the first point is between 270 and 315 degrees.

9. The tank pump (1) according to any one of the preceding claims, wherein the variable geometry infeed shelf (23) extends 360 degrees around the cylindrical inner surface of the tank wall (8) of said tank assembly (7).

10. The tank pump (1) according to any one of the preceding claims, wherein the variable geometry infeed shelf (23) is substantially planar in shape.

11. The tank pump (1) according to any one of the preceding claims, wherein the variable geometry infeed shelf (23) is provided below an upper rim (35) of the tank assembly (7) in an upper half of the tank assembly (7).

12. A method of manufacturing a tank pump (1) having a cylindrical tank assembly (7), a centrifugal pump (20) therein, and a drive assembly (2) comprising a motor (3) and optional transmission (4) provided atop the tank assembly (7); the method being CHARACTERISED IN THAT it comprises:
installing a variable geometry infeed shelf (23) into a cylindrical tank assembly (7) below an upper rim (35) of the tank assembly (7) in an upper half of the tank assembly (7), and below a tangential infeed conduit (9) to the tank assembly (7), such that the variable geometry infeed shelf (23) provides supplemental internal rigid stationary fluid boundary surfaces within the tank assembly (7) of the tank pump (1) and protrudes radially-inwardly from a cylindrical inner surface of a tank wall (8) of said tank assembly (7) below a tangential infeed conduit (9) to the tank assembly (7) to promote uniform feeding of the incoming flow around the tank (7) and into the submerged centrifugal pump (20) therein;
wherein the variable geometry infeed shelf (23) is configured to provide supplemental internal rigid stationary fluid boundary surfaces within the cylindrical tank assembly (7) of the tank pump (1) which produce uniform distribution of an incoming flow, the variable geometry infeed shelf (23) being annular and configured to protrude radially-inwardly from said cylindrical inner surface of a tank wall (8) of said tank assembly (7) below the tangential infeed conduit (9) to the tank assembly (7);
the variable geometry infeed shelf (23) being defined between a continuous annular inner edge (40) and a continuous annular outer edge (41), the variable geometry infeed shelf (23) being configured to abut said inner surface of the tank wall (8) along said continuous annular outer edge (41) below the upper rim (35) of the tank assembly (7) and below an inlet orifice (22) of the tangential infeed conduit (9); the variable geometry infeed shelf (23) further comprising:
a maximum radial width (D) located at a third point (31) on the continuous annular inner edge (40) adjacent the inlet orifice (22) of the tangential infeed conduit (9) and downstream of an infeed flow path (45) aligned with the tangential infeed conduit (9);
a minimum radial width (J) located at a first point (27) on the continuous annular inner edge (40);
a first section (26) configured to extend along the cylindrical inner surface of the tank wall (8) in a circumferential direction (Z2) between the third point (31) and the first point (27);
a transitioning blend or radius section (37) bridging end portions of the first section (26) and spanning the distance between the first point (27) and the third point (31) and configured to extend in the circumferential direction (Z2) along the cylindrical inner surface of the tank wall (8) between the first point (27) and the third point (31);
a transitioning radial width (K) of the transitioning blend or radius section (37) of the variable geometry infeed shelf (23) being located at a second point (29) on the continuous annular inner edge (40) between the first point (27) and the third point (31);
wherein an instantaneous radial width (I) of the first section (26) of the variable geometry infeed shelf (23) gradually decreases from the third point to the first point; and
wherein the transitioning radial width (K) is less than the maximum radial width (D) but greater than the minimum radial width (J).

13. The tank pump (1) according to claim 12, wherein the instantaneous radial width (I) of the variable geometry infeed shelf (23) gradually decreases at the same rate of change from the third point to the first point in the circumferential direction (Z2).

14. The method according to claim 12 or 13, wherein the transitioning blend or radius section (37) of the variable geometry infeed shelf (23) has a second section (28); wherein a portion of the continuous annular inner edge (40) defining the second section (28) has a first radius (r1) between the first point (27) and the second point (29).

15. The method according to any one of claims 12-14, wherein the transitioning blend or radius section (37) of the variable geometry infeed shelf (23) has a third section (30); wherein a portion of the continuous annular inner edge (40) defining the third section (30) has a second radius (r2) between the second point (29) and the third point (31).

16. The method according to any one of claims 12-15, wherein the variable geometry infeed shelf (23) protrudes radially-inwardly from the cylindrical inner surface of a tank wall (8) of said tank assembly (7) at a vertical distance (H) below an edge of the infeed orifice (22) of the tangential infeed conduit (9) to the tank assembly (7).

17. The method according to claim 16, wherein the vertical distance (H) is zero mm.

18. The method according to claim 16, wherein the vertical distance (H) is greater than zero mm.

19. The tank pump (1) according to any one of claims 12-18, wherein an angle (a) between the third point and the first point is between 270 and 315 degrees.

20. The method according to any one of claims 12-19, wherein the variable geometry infeed shelf (23) extends 360 degrees around the cylindrical inner surface of the tank wall (8) of said tank assembly (7).

21. The method according to any one of claims 12-20, wherein the variable geometry infeed shelf (23) is substantially planar in shape.

22. The method according to any one of claims 12-21, wherein the variable geometry infeed shelf (23) is provided below an upper rim (35) of the tank assembly (7) in an upper half of the tank assembly (7).
